(19) United States
(12) Patent Application Publication
(10) Pub. No.: US 2025/0015321 A1
(43) Pub. Date: Jan. 9, 2025

(54) CELL MONITORING DEVICE FOR FUEL CELL

(71) Applicants: Hyundai Motor Company, Seoul (KR); Kia Corporation, Seoul (KR)

(72) Inventor: Dae Han Ka, Yongin-si (KR)

(21) Appl. No.: 18/516,662

(22) Filed: Nov. 21, 2023

(30) Foreign Application Priority Data
Jul. 3, 2023 (KR) 10-2023-0085783

(51) Int. Cl. H01M 8/04537; H01M 8/0202; H01M 8/1018; H01M 8/2483

(52) U.S. Cl. CPC H01M 8/04559; H01M 8/0202; H01M 8/1018; H01M 8/2483; H01M 2008/1095

(57) ABSTRACT

An embodiment cell monitoring device for a fuel cell is provided. The cell monitoring device is mountable to a plurality of unit cells stacked in a first direction and includes a cell monitoring connector detachably connectable to a tab protruding from a side portion of a separator included in the unit cells in a second direction intersecting the first direction, a joint connector including a joint terminal guidable by a connection terminal to be inserted into the cell monitoring connector, and a controller disposed on a rear surface of the joint connector and directly connectable to a second end portion of the joint terminal opposite the first end portion to sense a voltage of each of the unit cells, the joint connector and the controller each being shaped to press a first end portion of the joint terminal toward the tab.

### CROSS-REFERENCE TO RELATED APPLICATIONS

This application claims the benefit of Korean Patent Application No. 10-2023-0085783, filed on Jul. 3, 2023, which application is hereby incorporated herein by reference.

### TECHNICAL FIELD

Embodiments relate to a cell monitoring device for a fuel cell.

### BACKGROUND

A cell stack of a fuel cell may supply power, generated through electrochemical reaction between air supplied to one surface of a polymer electrolyte membrane and hydrogen supplied to the opposite surface of the polymer electrolyte membrane, to an external load.

A cell stack may have a structure in which hundreds of unit cells are stacked. When the unit cells operate normally during operation of the cell stack, the unit cells may form a predetermined magnitude of voltage. If any one of hundreds of cells fails to exhibit normal performance, the total output of the cell stack is lowered. If the reverse voltage phenomenon continues, operation of the cell stack needs to be stopped. A cell monitoring device checks the state of each of the unit cells of the cell stack and continuously monitors the voltage of each of the unit cells. To this end, the cell monitoring device may be electrically connected to the cells in order to check the voltage of each of the unit cells constituting the cell stack. Various studies for simplifying the structure of a cell monitoring device are being carried out.

Korean Patent Registration No. 10-1337937 (registered on Dec. 2, 2013, and entitled “Connector for Measuring Cell Voltage of Fuel Cell Stack” as translated), which is the counterpart to U.S. Patent Publication No. 2013/0316560 (published Nov. 28, 2013), may provide information related to the subject matter of the present application.

### SUMMARY

Accordingly, embodiments are directed to a cell monitoring device for a fuel cell that substantially obviates one or more problems due to limitations and disadvantages of the related art.

Embodiments provide a compact cell monitoring device for a fuel cell, which has a simple configuration.

However, the objects to be accomplished by the embodiments are not limited to the above-mentioned objects, and other objects not mentioned herein will be clearly understood by those skilled in the art from the following description.

Additional advantages, objects, and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

To achieve these objects and other advantages and in accordance with the purpose of the disclosure, as embodied and broadly described herein, a cell monitoring device for a fuel cell, which is mounted to a plurality of unit cells stacked in a first direction, may include a cell monitoring connector configured to be detachably coupled to a separator included in the plurality of unit cells to be connected to a tab protruding from a side portion of the separator in a second direction intersecting the first direction, a joint connector including a joint terminal configured to be guided by a connection terminal to be inserted into the cell monitoring connector and shaped so as to press an end portion of the joint terminal toward the tab, and a controller configured to be directly connected to the opposite end portion of the joint terminal to sense a voltage of each of the plurality of unit cells and disposed on the rear surface of the joint connector so as to press the end portion of the joint terminal toward the tab.

In an example, the cell monitoring connector may include a housing including a side coupled to the tab and an opposite side, wherein the connection terminal may be inserted into the opposite side of the housing to be connected to the tab, and a CPA configured to be coupled to the housing to prevent the housing from being separated from the separator in the second direction.

In an example, the connection terminal may include a connection portion configured to be inserted into a connection terminal insertion hole formed in the opposite side of the housing to be connected to the tab, a joint guide portion configured to guide the joint terminal, a stabilizer protruding in a third direction intersecting each of the first and second directions to prevent the connection terminal from being inserted inversely into the housing, and a locking protrusion formed so as to be bent and extend downward from the connection portion.

In an example, the joint connector may further include a joint body formed to allow the joint terminal to pass therethrough and disposed between the cell monitoring connector and the controller, and the end portion of the joint terminal may be inserted into the joint guide portion to be disposed in the connection terminal.

In an example, the controller may include a control body configured to be directly connected to the opposite end portion of the joint terminal and to contact the rear surface of the joint connector and a sensing unit configured to be directly connected to the opposite end portion of the joint terminal to sense the voltage.

In an example, the joint body may include first coupling portions configured to be coupled to the housing while pressing the joint terminal so that the end portion of the joint terminal is inserted into the joint guide portion.

In an example, the housing may include first protruding portions protruding in the third direction, and the first coupling portions may be formed in the shape of tongs so as to be engaged with the first protruding portions.

In an example, the control body may include second coupling portions configured to be coupled to the housing while pressing the joint terminal so that the end portion of the joint terminal is inserted into the joint guide portion.

In an example, the housing may include second protruding portions protruding in the third direction and disposed closer to the separator than the first protruding portions, and the second coupling portions may be formed in the shape of tongs so as to be engaged with the second protruding portions.

In an example, the cell monitoring device may further include a protective cover configured to be fastened to the fuel cell to cover at least a portion of an outermost side of each of the joint connector and the controller.

It is to be understood that both the foregoing general description and the following detailed description of embodiments of the present disclosure are exemplary and explanatory and are intended to provide further explanation of the embodiments of the disclosure as claimed.

### BRIEF DESCRIPTION OF THE DRAWINGS

The accompanying drawings, which are included to provide a further understanding of embodiments of the invention and are incorporated in and constitute a part of this application, illustrate embodiments of the invention and together with the description serve to explain the principle of the embodiments of the invention. In the drawings:

FIG. 1A is a coupled perspective view of a cell monitoring device for a fuel cell according to an embodiment;

FIG. 1B is an exploded perspective view of the cell monitoring device for a fuel cell according to the embodiment shown in FIG. 1A;

FIG. 2 is a perspective view showing the external appearance of a general fuel cell;

FIG. 3 is a cross-sectional view of end plates and a cell stack in the fuel cell shown in FIG. 2;

FIG. 4 is a front view of separators shown in FIG. 3 when viewed in the +x-axis direction;

FIG. 5A is a coupled cross-sectional view of an embodiment of the cell monitoring device, cut along line I-I′ in FIG. 1A;

FIG. 5B is an exploded cross-sectional view of an embodiment of the cell monitoring device shown in FIG. 5A;

FIG. 5C is an enlarged view of portion ‘A’ shown in FIG. 5A;

FIG. 5D is a coupled perspective view of the cell monitoring device for a fuel cell shown in FIG. 5A, with a controller removed therefrom;

FIG. 5E is a coupled cross-sectional view of an embodiment of the cell monitoring device, with the controller removed therefrom;

FIGS. 6A, 6B, and 6C are, respectively, an upper perspective view, a lower perspective view, and an upper cross-sectional view of an embodiment of connection terminals shown in FIGS. 5A and 5B;

FIGS. 7A and 7B are plan views of various embodiments of a joint connector;

FIG. 8 is a rear perspective view of a cell monitoring device for a fuel cell according to another embodiment;

FIG. 9 is a rear view of a cell monitoring device for a fuel cell according to still another embodiment;

FIGS. 10A to 10D are perspective views showing a process of manufacturing the cell monitoring device according to an embodiment;

FIG. 11 is a cross-sectional view of a cell monitoring device for a fuel cell according to a comparative example; and

FIG. 12 is a partial perspective view of the cell monitoring device according to the comparative example.

### DETAILED DESCRIPTION OF ILLUSTRATIVE EMBODIMENTS

Embodiments of the present disclosure will now be described more fully hereinafter with reference to the accompanying drawings, in which various embodiments are shown. The examples, however, may be embodied in many different forms and should not be construed as being limited to the embodiments set forth herein. Rather, these embodiments are provided so that this disclosure will be more thorough and complete, and will more fully convey the scope of the embodiments of the disclosure to those skilled in the art.

It will be understood that when an element is referred to as being “on” or “under” another element, it may be directly on/under the element, or one or more intervening elements may also be present.

When an element is referred to as being “on” or “under,” “under the element” as well as “on the element” may be included based on the element.

In addition, relational terms, such as “first,” “second,” “on/upper part/above” and “under/lower part/below,” are used only to distinguish between one subject or element and another subject or element, without necessarily requiring or involving any physical or logical relationship or sequence between the subjects or elements.

Hereinafter, a cell monitoring device for a fuel cell according to an embodiment will be described with reference to the accompanying drawings. The cell monitoring device will be described using the Cartesian coordinate system (x-axis, y-axis, z-axis) for convenience of description, but may also be described using other coordinate systems. In the Cartesian coordinate system, the x-axis, the y-axis, and the z-axis are perpendicular to each other, but the embodiments are not limited thereto. That is, the x-axis, the y-axis, and the z-axis may intersect each other obliquely. In the following description, the x-axis direction will be referred to as a “first direction,” the y-axis direction will be referred to as a “second direction,” and the z-axis direction will be referred to as a “third direction” for convenience of description.

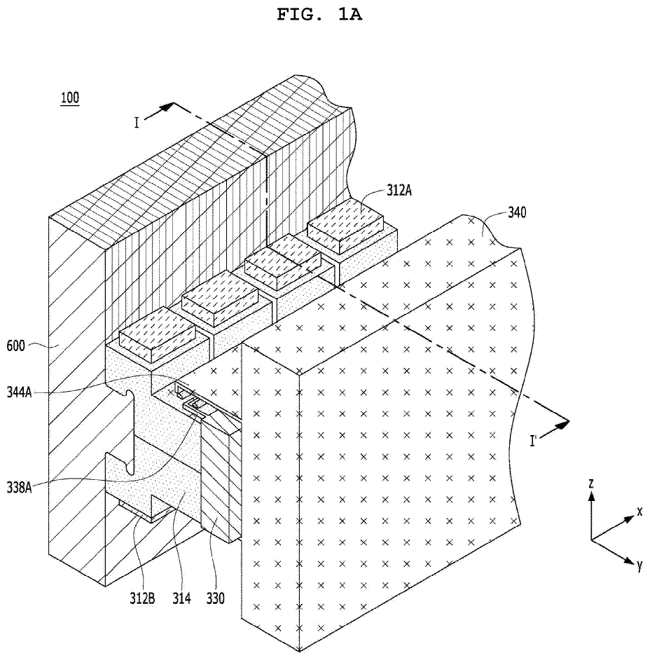

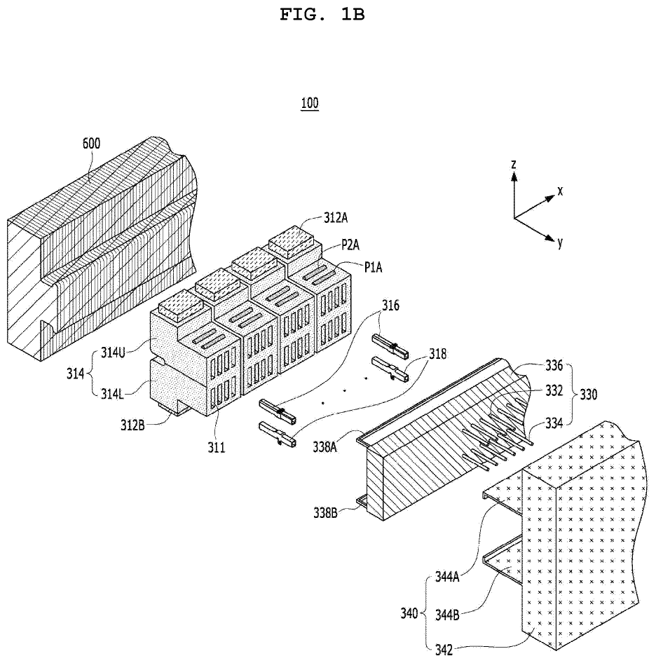

FIG. 1A is a coupled perspective view of a cell monitoring device 100 for a fuel cell according to an embodiment, and FIG. 1B is an exploded perspective view of the cell monitoring device 100 for a fuel cell according to the embodiment shown in FIG. 1A.

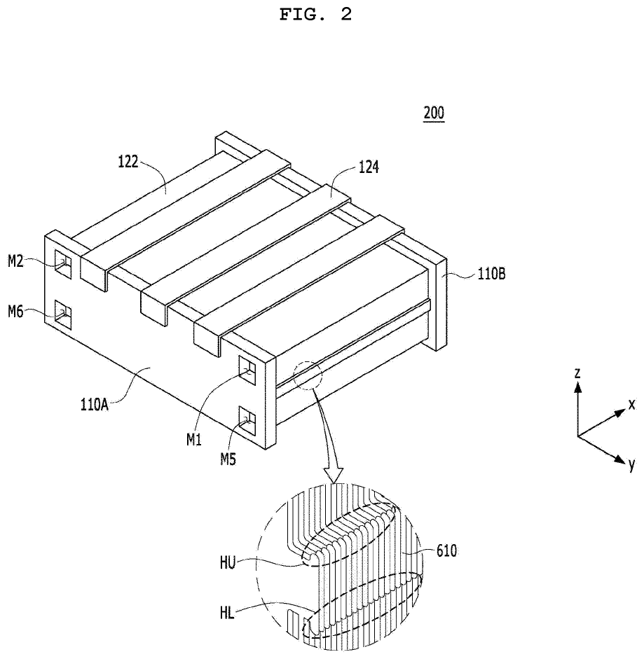

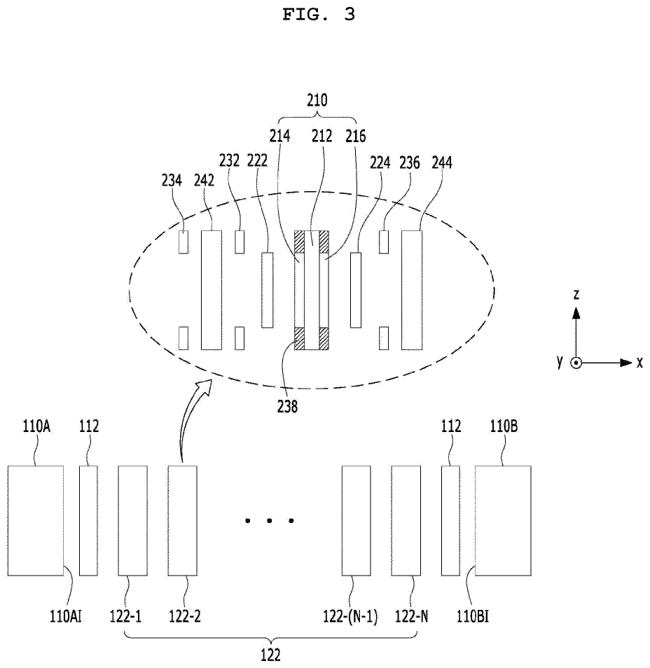

FIG. 2 is a perspective view showing the external appearance of a general fuel cell 200, and FIG. 3 is a cross-sectional view of end plates 110A and 110B and a cell stack 122 in the fuel cell 200 shown in FIG. 2.

For better understanding, the cell monitoring device 100 for a fuel cell according to the embodiment will be described as monitoring the fuel cell 200 shown in FIG. 2. However, the embodiments are not limited thereto. That is, the cell monitoring device 100 for a fuel cell according to the embodiment may also monitor a fuel cell configured differently from the fuel cell 200 shown in FIG. 2.

The fuel cell 200 shown in FIG. 2 may be, for example, a polymer electrolyte membrane fuel cell (or a proton exchange membrane fuel cell) (PEMFC), which has been studied most extensively as a power source for driving vehicles.

The fuel cell 200 may further include end plates (pressing plates or compression plates) 110A and 110B, a cell stack 122, and a clamping member 124.

The cell stack 122 may include a plurality of unit cells 122-1 to 122-N, which are stacked in the first direction. Here, “N” is a positive integer of 1 or greater and may range from several tens to several hundreds. However, the embodiments are not limited to any specific value of “N.”

Each unit cell 122-n may generate electricity having a predetermined voltage. Here, 1 ≤ n≤ N. “N” may be determined depending on the intensity of the power to be supplied from the fuel cell 200 to a load. Here, the load may be a part of a vehicle that requires power when the fuel cell 200 is used in the vehicle.

Each unit cell 122-n may include a membrane electrode assembly (MEA) 210, gas diffusion layers (GDLs) 222 and 224, gaskets 232, 234, and 236, and separators (or bipolar plates) 242 and 244.

The membrane electrode assembly 210 has a structure in which catalyst electrode layers, in which electrochemical reaction occurs, are attached to both sides of an electrolyte membrane through which hydrogen ions move. In detail, the membrane electrode assembly 210 may include a polymer electrolyte membrane (or a proton exchange membrane) 212, a fuel electrode (a hydrogen electrode or an anode) 214, and an air electrode (an oxygen electrode or a cathode) 216. In addition, the membrane electrode assembly 210 may further include a sub-gasket 238.

The polymer electrolyte membrane 212 is disposed between the fuel electrode 214 and the air electrode 216.

Hydrogen as a fuel in the fuel cell 200 may be supplied to the fuel electrode 214 through the first separator 242, and air containing oxygen as an oxidizer may be supplied to the air electrode 216 through the second separator 244.

The hydrogen supplied to the fuel electrode 214 is decomposed into hydrogen ions (protons) (H+) and electrons (e−) by the catalyst. Only the hydrogen ions may be selectively transferred to the air electrode 216 through the polymer electrolyte membrane 212, and at the same time, the electrons may be transferred to the air electrode 216 through the separators 242 and 244, which are conductors. Such movement of the electrons causes flow of the electrons through an external wire, whereby a current is generated. That is, the fuel cell 200 may generate power due to the electrochemical reaction between hydrogen, which is a fuel, and oxygen contained in the air.

In the air electrode 216, the hydrogen ions supplied through the polymer electrolyte membrane 212 and the electrons transferred through the separators 242 and 244 meet oxygen in the air supplied to the air electrode 216, thus causing a reaction that generates water (“condensed water” or “product water”).

The gas diffusion layers 222 and 224 serve to uniformly distribute hydrogen and oxygen, which are reactant gases, and to transfer generated electrical energy. To this end, the gas diffusion layers 222 and 224 may be disposed on respective sides of the membrane electrode assembly 210. That is, the first gas diffusion layer 222 may be disposed on the left side of the fuel electrode 214, and the second gas diffusion layer 224 may be disposed on the right side of the air electrode 216.

The first gas diffusion layer 222 may serve to diffuse and uniformly distribute hydrogen supplied as a reactant gas through the first separator 242 and may be electrically conductive. The second gas diffusion layer 224 may serve to diffuse and uniformly distribute air supplied as a reactant gas through the second separator 244 and may be electrically conductive.

Each of the first and second gas diffusion layers 222 and 224 may be a microporous layer in which fine carbon fibers are combined. However, the embodiments are not limited to any specific configuration of the first and second gas diffusion layers 222 and 224.

The gaskets 232, 234, and 236 may serve to maintain airtightness and clamping pressure of the cell stack at an appropriate level with respect to the reactant gases and the coolant, to disperse stress when the separators 242 and 244 are stacked, and to independently seal flow paths. As such, since airtightness and watertightness are maintained by the gaskets 232, 234, and 236, the flatness of the surfaces that are adjacent to the cell stack 122, which generates power, may be secured, and thus surface pressure may be distributed uniformly over the reaction surface of the cell stack 122. To this end, the gaskets 232, 234, and 236 may be formed of rubber. However, the embodiments are not limited to any specific material of the gaskets.

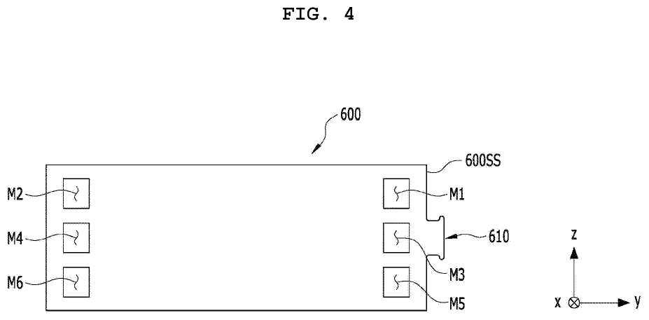

FIG. 4 is a front view of the separators 242 and 244 shown in FIG. 3 when viewed in the +x-axis direction.

The separators 242 and 244 may serve to move the reactant gases and the cooling medium and to separate each of the unit cells from the other unit cells. In addition, the separators 242 and 244 may also serve to structurally support the membrane electrode assembly 210 and the gas diffusion layers 222 and 224 and to collect the generated current and transfer the collected current to current collectors 112.

The separators 242 and 244 may be disposed outside the gas diffusion layers 222 and 224, respectively. That is, the first separator 242 may be disposed on the left side of the first gas diffusion layer 222, and the second separator 244 may be disposed on the right side of the second gas diffusion layer 224.

The first separator 242 serves to supply hydrogen as a reactant gas to the fuel electrode 214 through the first gas diffusion layer 222. The second separator 244 serves to supply air as a reactant gas to the air electrode 216 through the second gas diffusion layer 224. In addition, each of the first and second separators 242 and 244 may form a channel through which a cooling medium (e.g., coolant) may flow. Further, the separators 242 and 244 may be formed of a graphite-based material, a composite graphite-based material, or a metal-based material. However, the embodiments are not limited to any specific material of the separators 242 and 244.

The end plates 110A and 110B shown in FIG. 1 may be disposed at the respective ends of the cell stack 122 and may support and fix the unit cells. That is, the first end plate 110A may be disposed at one end of the cell stack 122, and the second end plate 110B may be disposed at the opposite end of the cell stack 122.

The current collectors 112 may be disposed between the cell stack 122 and the inner surfaces 110AI and 110BI of the end plates 110A and 110B that face the cell stack 122. The current collectors 112 serve to collect the electrical energy generated by the flow of electrons in the cell stack 122 and to supply the electrical energy to a load that uses the fuel cell.

Further, at least one of the first or second end plate 110A or 110B may include a plurality of manifolds (or communicating portions) M. Each of the first and second separators 242 and 244 shown in FIG. 3 may include manifolds M1, M2, M5, and M6, as shown in FIG. 4. Here, the manifolds may include inlet manifolds M1 and M2 and outlet manifolds M5 and M6. Hydrogen and oxygen, which are reactant gases necessary in the membrane electrode assembly 210, may be introduced from the outside into the cell stack 122 through the inlet manifolds M1 and M2. Gas or liquid, in which the reactant gases humidified and supplied to the cell and the condensed water generated in the cell are combined, may be discharged to the outside of the fuel cell through the outlet manifolds M5 and M6. Further, the cooling medium may flow from the outside into the cell stack 122 through an inlet manifold M3 (or M4) and may flow outside through an outlet manifold M4 (or M3). As described above, the manifolds M1 to M6 allow the fluid to flow into and out of the membrane electrode assembly 210.

For example, as shown in FIG. 2, the manifolds M1, M2, M5, and M6 may be disposed in the first end plate 110A, and the manifolds M3 and M4 may be disposed in the second end plate 110B. Alternatively, the manifolds M1 to M6 may be disposed in the first or second end plate 110A or 110B.

The clamping member 124 serves to clamp the plurality of unit cells together with the end plates 110A and 110B in the first direction. For example, as shown in FIG. 2, the clamping member 124 may have a bar shape, but the embodiments are not limited thereto. That is, according to another embodiment, the clamping member 124 may have a long bolt shape, a belt shape, or a rigid rope shape to clamp the plurality of unit cells.

Referring back to FIGS. 1A and 1B, the cell monitoring device 100 may be mounted to the plurality of unit cells to measure voltage of each of the unit cells, and the cell monitoring device 100 may check performance and occurrence of failure of a corresponding unit cell included in the cell stack 122 using a measurement result.

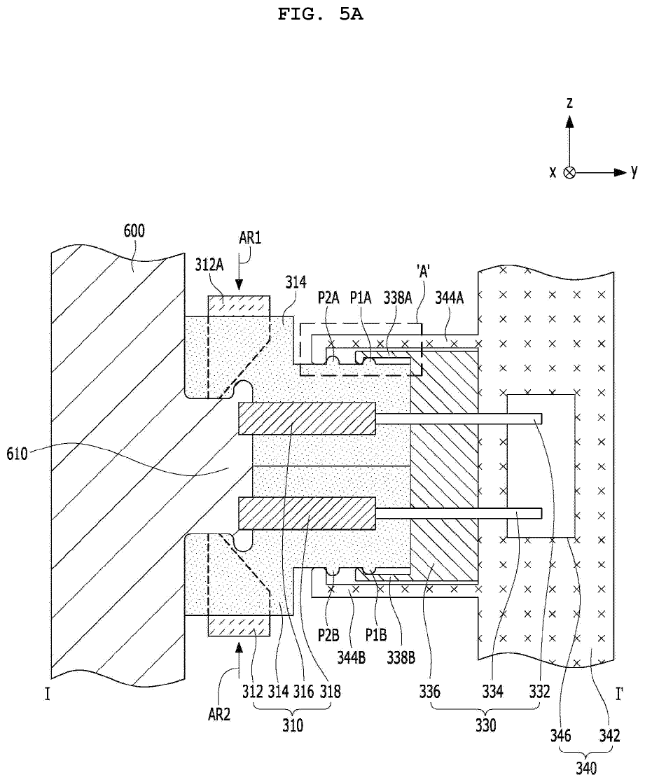

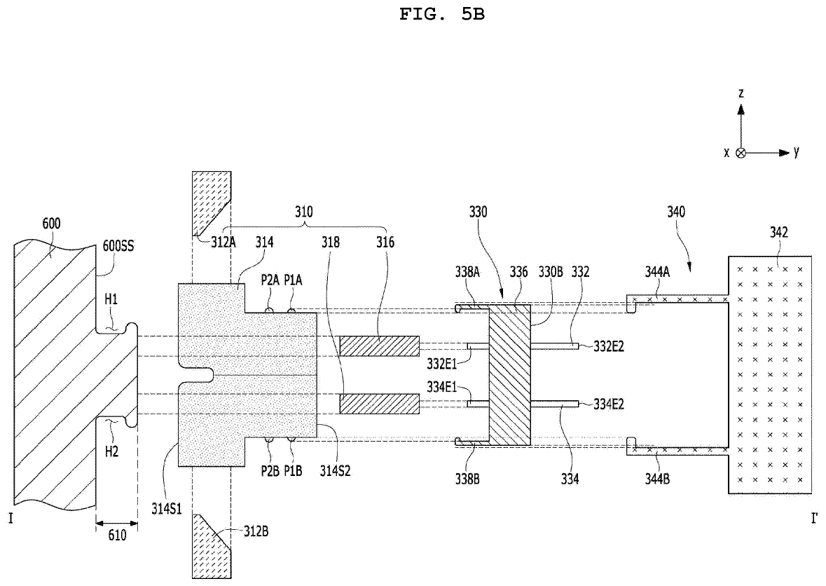

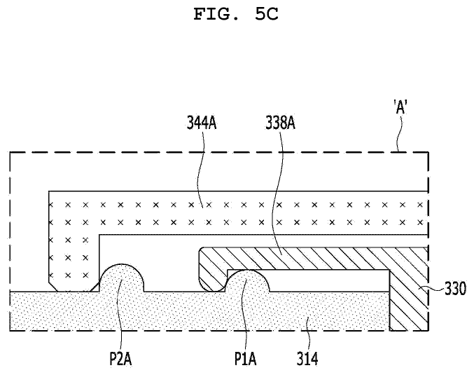

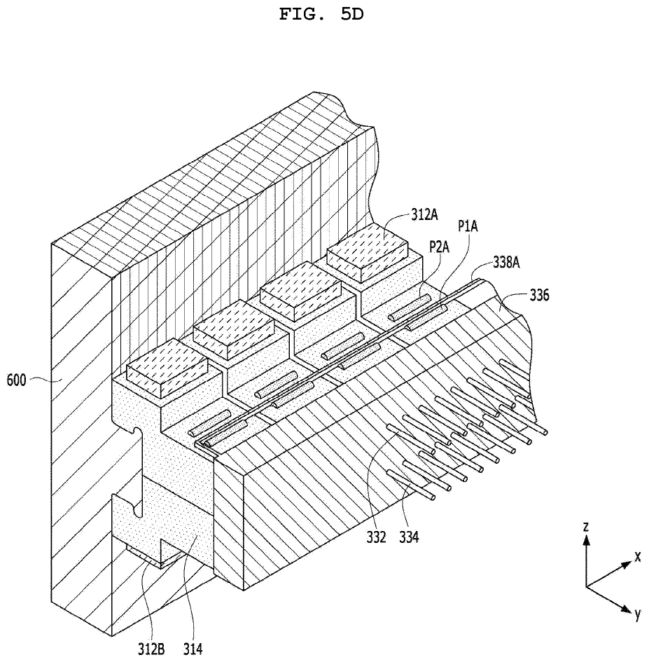

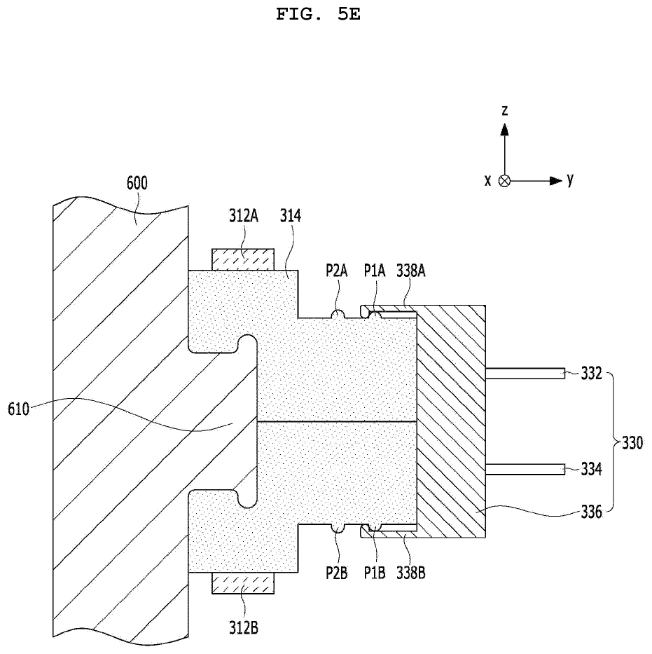

FIG. 5A is a coupled cross-sectional view of an embodiment of the cell monitoring device 100, cut along line I-I′ in FIG. 1A. FIG. 5B is an exploded cross-sectional view of an embodiment of the cell monitoring device 100 shown in FIG. 5A. FIG. 5C is an enlarged view of portion ‘A’ shown in FIG. 5A. FIG. 5D is a coupled perspective view of the cell monitoring device 100 for a fuel cell shown in FIG. 5A, with a controller 340 removed therefrom. FIG. 5E is a coupled cross-sectional view of an embodiment of the cell monitoring device 100, with the controller 340 removed therefrom.

For better understanding, in FIG. 5A, a first connector position assurance (CPA) 312A and a second CPA 312B, which are disposed in a housing 314 and thus are invisible, are indicated by dotted lines.

A cell monitoring connector 310 may include CPAS 312 (312A and 312B), a housing 314, and connection terminals 316 and 318. In this case, the cell monitoring connector 310 according to the embodiment is not limited to any specific shapes of the connection terminals 316 and 318 and the CPAs 312. For example, the CPAs 312 may be fastened to the housing 314 in the same manner as that in which the housing 110 and the CPAs 140 disclosed in the related art document (Korean Patent Registration No. 10-1337937) are fastened to each other.

The housing 314 may be detachably coupled to separators 600 included in the plurality of unit cells 122-1 to 122-N. The housing 314 may be made of plastic that is insulated from other parts and has strength for mechanically fixing the connection terminals 316 and 318, but the embodiments are not limited to any specific material of the housing 314. The housing 314 may include a side 314S1, which is coupled to tabs 610 of the separators 600, and another side 314S2, which is opposite the side 314S1.

The separators 600 shown in FIGS. 1A, 5A, and 5B may correspond to the separators 242 and 244 shown in FIGS. 2 to 4.

As shown in FIGS. 2 and 4, each of the separators 600 may include a tab 610 protruding from a side portion 600SS thereof in the second direction. Here, the second direction may be a direction in which the side portion 600SS of the separator 600 faces the cell monitoring connector 310. The cell monitoring connector 310 may be coupled to the tab 610. That is, the cell monitoring connector 310 may serve as a female terminal, and the tab 610 of each of the separators 600 aligned in a row may serve as a male terminal, whereby the cell monitoring connector 310 and the tabs 610 of the separators 600 may be coupled to each other.

The plurality of separators 600 included in the cell stack 122 may be some of all separators included in the fuel cell 200. For example, all separators included in the fuel cell 200 may be grouped into unit groups, and each unit group may include a plurality of separators 600. For example, each unit group may include ten separators 600, and one cell monitoring connector 310 may be mounted to each unit group.

For example, ten separators may be coupled to the housing 314 in a zigzag pattern. That is, assuming that first to tenth separators are included in a unit group, odd-numbered separators may be coupled to one of an upper housing 314U and a lower housing 314L, and even-numbered separators may be coupled to the other of the upper housing 314U and the lower housing 314L. However, the embodiments are not limited to any specific coupling pattern of the housing 314 and the separators 600.

A recess (hereinafter referred to as a “lock recess”) may be formed in at least one of the upper portion or the lower portion of the tab 610 included in each of the separators 600. For example, as illustrated in FIG. 5B, a lock recess H1 (hereinafter referred to as a “first lock recess”) may be formed in the upper portion of the tab 610 of each of the separators 600, and a lock recess H2 (hereinafter referred to as a “second lock recess”) may be formed in the lower portion of the tab 610 of each of the separators 600, but the embodiments are not limited thereto. Hereinafter, a configuration in which both the first lock recess H1 and the second lock recess H2 are formed in the tab 610 will be described. However, the embodiments are not limited thereto.

According to another embodiment, the lock recess H1 or H2 may be formed only in one of the upper portion and the lower portion of the tab 610, and the following description may also be applied to this embodiment.

The first and second lock recesses H1 and H2 formed in each of the separators 600 belonging to the unit group may be disposed so as to overlap the first and second lock recesses H1 and H2 formed in an adjacent separator 600 in the first direction. The first and second lock recesses H1 and H2 overlapping in the first direction may define groove potions, which are receiving spaces in which the cell monitoring connector 310 is mounted. For example, referring to FIG. 2, the first lock recesses H1 overlapping in the first direction may define a first groove portion HU, which is a receiving space in which the cell monitoring connector 310 is mounted, and the second lock recesses H2 overlapping in the first direction may define a second groove portion HL, which is a receiving space in which the cell monitoring connector 310 is mounted. That is, the first groove portion HU may be formed by arrangement of the first lock recesses H1 formed in the upper portions of the tabs 610, and the second groove portion HL may be formed by arrangement of the second lock recesses H2 formed in the lower portions of the tabs 610.

The connection terminals 316 and 318 may be inserted into the cell monitoring connector 310 to be directly connected to the tabs 610. That is, the connection terminals 316 and 318 may be inserted into connection terminal insertion holes 311 in the other side 314S2 of the housing 314 to be electrically connected to the tabs 610 of the plurality of separators 600.

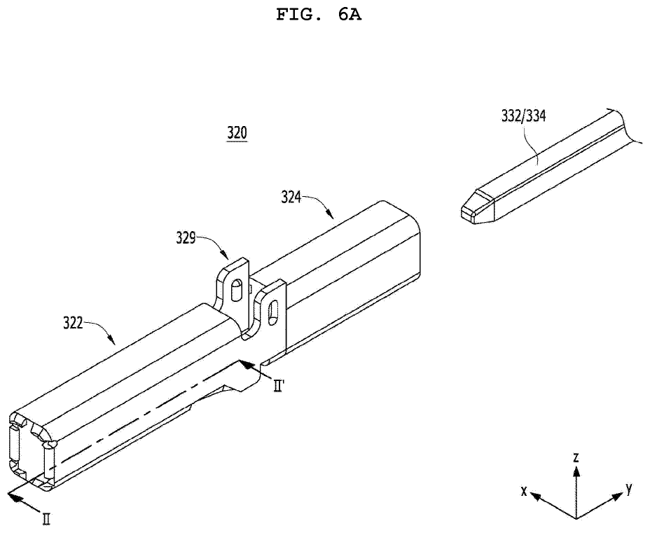

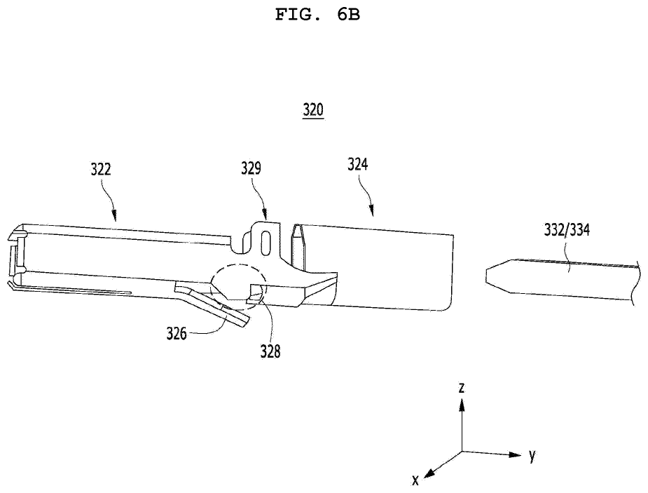

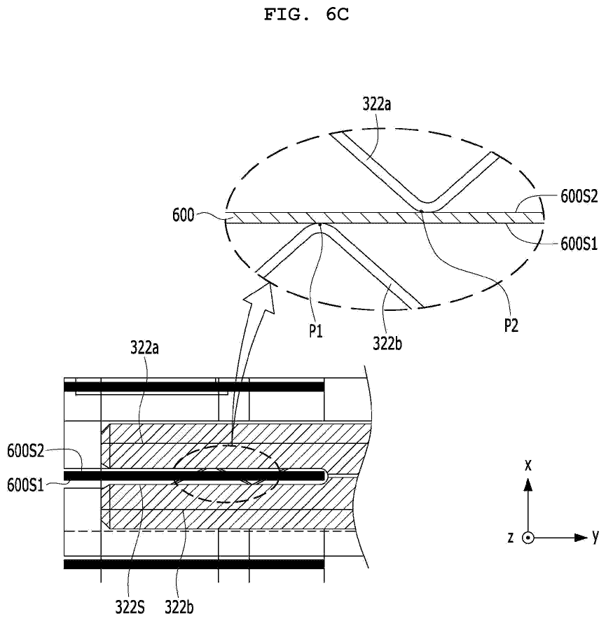

FIGS. 6A, 6B, and 6C are, respectively, an upper perspective view, a lower perspective view, and an upper cross-sectional view of an embodiment of the connection terminals 316 and 318 shown in FIGS. 5A and 5B. FIG. 6C corresponds to a plan view of a terminal connection portion 322 when viewed from above after being cut along line II-II′ in FIG. 6A.

For example, referring to FIGS. 6A and 6B, the connection terminal 320 may include a connection portion 322 and a joint guide portion 324. The connection portion 322 is a portion that is inserted into a corresponding connection terminal insertion hole 311 formed in the other side 314S2 of the housing 314 to be connected to the tab 610 of a corresponding separator 600, and the joint guide portion 324 is a portion that guides a joint terminal 332 or 334 to be described later. That is, the joint guide portion 324 serves as a guide path along which the joint terminal 332 or 334 is inserted into the housing 314.

Referring to FIG. 6C, the connection portion 322 may include connection pieces 322a and 322b, which are elastically spread by contact with the two opposite surfaces 600S1 and 600S2 of the separator 600. Connection points P1 and P2 of the connection pieces 322a and 322b may be disposed so as to be offset from each other. As such, according to the embodiment, since the connection points P1 and P2 of the connection pieces 322a and 322b are offset from each other, when the separator 600 is inserted into a second slit 322S defined by the two connection pieces 322a and 322b, the contact force between the separator 600 and the connection pieces 322a and 322b may increase, and thus the separator 600 may be supported more securely. Thus, even when the separator 600 is implemented as an ultra-thin film having a thickness of 0.1 mm or less, the connection terminal 320 may be prevented from being unintentionally separated from the separator 600. That is, the force of holding the connection terminal 320 may increase, which results in improved product reliability.

The connection portion 322 of the connection terminal 320 may have a rectangular parallelepiped shape having an opening formed in the front side thereof, but the embodiments are not limited thereto.

In addition, the connection terminal 320 may further include a locking protrusion (or a lance) 326. The locking protrusion 326 may be disposed on the lower surface of the connection portion 322. The locking protrusion 326 may be bent and extend downward from the lower surface of the connection portion 322 to fix the connection terminal 320 to the housing 314.

In addition, the connection terminal 320 may further include a connection guide portion 328. The connection guide portion 328 may prevent the connection terminal 320, connected to the separator 600 through the housing 314, from being separated from the separator 600.

In addition, the connection terminal 320 may further include a stabilizer 329. The stabilizer 329 protrudes in the third direction intersecting each of the first and second directions to prevent the connection terminal 320 from being inserted inversely into the housing 314.

Meanwhile, after the cell monitoring connector 310 is fastened to the separator 600, the CPA 312 may be selectively inserted into the lock portion in the housing 314 in the third direction from at least one of the upper end or the lower end of the cell monitoring connector 310, and thus may be locked in the groove portion. For example, as illustrated, in the case in which the first and second groove portions HU and HL are formed in the upper portion and the lower portion of the tab 610, respectively, the CPA 312 may include first and second CPAS 312A and 312B.

For example, as shown in FIG. 5A, each of the CPAs 312A and 312B is pressed in the third direction, which is a vertical direction, so that the housing 314 is locked to the tab 610 of the separator 600, thereby preventing the cell monitoring connector 310 from being unintentionally dismantled and separated.

After the cell monitoring connector 310 is fastened to the separators 600, the first CPA 312A may be selectively inserted into the housing 314 from the upper end of the cell monitoring connector 310 in the third direction (e.g., the −z-axis direction, which is a direction indicated by the arrow AR1 in FIG. 5A) to be locked in the first groove portion HU. In addition, after the cell monitoring connector 310 is fastened to the separators 600, the second CPA 312B may be selectively inserted into the housing 314 from the lower end of the cell monitoring connector 310 in the third direction (e.g., the +z-axis direction, which is a direction indicated by the arrow AR2 in FIG. 5A) to be locked in the second groove portion HL.

As such, since the first and second CPAs 312A and 312B are locked in the first and second groove portions HU and HL, respectively, the housing 314 is secured to the separators 600, thereby preventing the cell monitoring connector 310 from being separated from the separators 600 in the second direction due to external vibration and impact. In this way, each of the first and second CPAs 312A and 312B is a kind of locking device. The first and second CPAs 312A and 312B may be made of plastic.

The joint connector 330 may include joint terminals 332 and 334 and a joint body 336.

Each of the joint terminals 332 and 334 is guided by the connection terminal 320 to be inserted into the cell monitoring connector 310. That is, as shown in FIGS. 5A and 5B, one end portion 332E1 or 334E1 of the joint terminal 332 or 334 is inserted into the joint guide portion 324 to be disposed in the connection terminal 320, and the other end portion 332E2 or 334E2 of the joint terminal 332 or 334 is directly connected to the controller 340.

The number of joint terminals 332 and 334 may be identical to the number of separators 600. If one cell monitoring connector 310 is coupled to ten separators belonging to a unit group, the number of joint terminals may be ten. In the case in which ten separators are coupled to the housing 314 in a zigzag pattern as described above, the number of joint terminals 332 connected to the separators coupled to the upper housing 314U is five, and the number of joint terminals 332 connected to the separators coupled to the lower housing 314L is five. That is, a total of ten joint terminals may be required. In this case, each of the joint terminals 332 and 334 may be connected to the tab 610 via the connection portion 322, rather than being directly connected to the separator 600.

The joint body 336 is a part through which the joint terminals 332 and 334 pass, and may be disposed between the cell monitoring connector 310 and the controller 340.

The joint connector 330 is shaped so as to press the end portions 332E1 and 334E1 of the joint terminals 332 and 334 toward the tabs 610. To this end, for example, the joint body 336 may include first coupling portions 338A and 338B. As shown in FIG. 5A, the first coupling portions 338A and 338B may be coupled to the housing 314 while pressing the joint terminals 332 and 334 so that the end portions 332E1 and 334E1 of the joint terminals 332 and 334 are inserted into the joint guide portions 324. To this end, the housing 314 may include first protruding portions P1A and P1B protruding in the third direction, and the first coupling portions 338A and 338B may be formed in the shape of tongs so as to be engaged with the first protruding portions P1A and P1B. When the first coupling portions 338A and 338B are pressed in the −y-axis direction, which is the second direction, the first coupling portions 338A and 338B may move over the first protruding portions PIA and P1B. To this end, the first coupling portions 338A and 338B may be made of a flexible material, e.g., plastic.

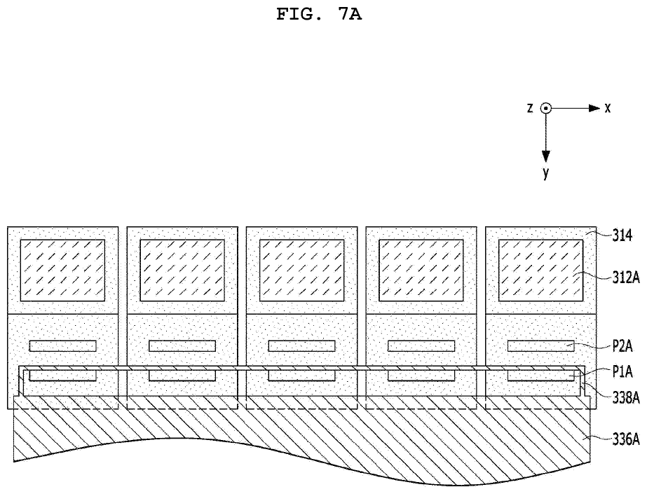

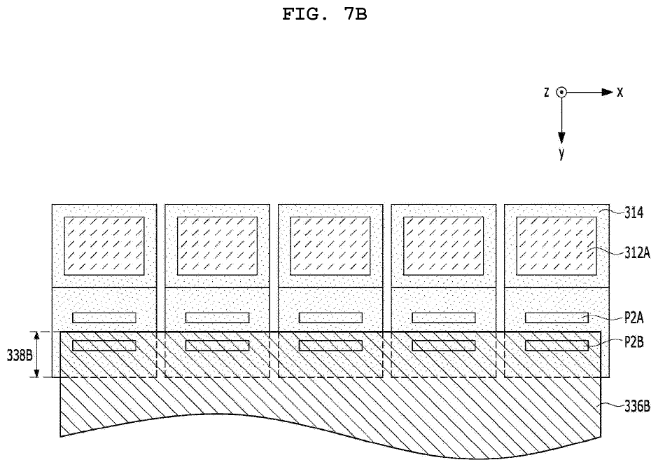

FIGS. 7A and 7B are plan views of various embodiments of the joint connector 330. For better understanding, in FIGS. 7A and 7B, an invisible portion of the housing 314 that is hidden by a joint body 336A or 336B is indicated by dotted lines.

The joint body 336A or 336B may be coupled to a plurality of housings 314. For example, as shown in FIGS. 7A and 7B, the joint body 336A or 336B may be coupled to five housings 314. However, the embodiments are not limited to any specific number of housings 314 coupled to one joint body 336A or 336B.

According to an embodiment, as shown in FIGS. 5D and 7A, the first coupling portion 338A extending from the joint body 336A may have a cavity defined between the joint body 336A and a part of the first coupling portion 338A that is engaged with the first protruding portion PIA. In this case, the first protruding portion PIA may be exposed to the outside through the cavity in the state of being engaged with the first coupling portion 338A.

According to another embodiment, as shown in FIG. 7B, the first coupling portion 338B extending from the joint body 336B may have no cavity therein. In this case, after being engaged with the first coupling portion 338B, the first protruding portion P1A is covered by the first coupling portion 338B and thus is not exposed to the outside.

The controller 340 is directly connected to the other end portions 332E2 and 334E2 of the joint terminals 332 and 334 and serves to sense the voltage of each of the plurality of unit cells. To this end, the joint connector 330 serves to assist in electrical connection and assembly between the cell monitoring connector 310 and the controller 340.

According to the embodiment, the controller 340 may include a control body 342 and a sensing unit 346.

The control body 342 may be directly connected to the other end portions 332E2 and 334E2 of the joint terminals 332 and 334 and may be disposed in contact with a rear surface 330B of the joint connector 330.

The sensing unit 346 is directly connected to the other end portions 332E2 and 334E2 of the joint terminals 332 and 334 to sense the voltage of each of the plurality of unit cells. FIG. 5A merely illustrates a concept of the sensing unit 346. The embodiments are not limited to any specific position at which the sensing unit 346 is disposed in the control body 342. Further, the embodiments are not limited to any specific connection structure or pattern between the sensing unit 346 and the other end portions 332E2 and 334E2 of the joint terminals 332 and 334.

Further, the controller 340 may be disposed on the rear surface 330B of the joint connector 330 and may be shaped so as to press the end portions 332E1 and 334E1 of the joint terminals 332 and 334 toward the tabs 610. To this end, the control body 342 may include second coupling portions 344A and 344B. The second coupling portions 344A and 344B may be coupled to the housing 314 while pressing the joint terminals 332 and 334 so that the end portions 332E1 and 334E1 of the joint terminals 332 and 334 are inserted into the joint guide portions 324. To this end, the housing 314 may include second protruding portions P2A and P2B for engagement with the second coupling portions 344A and 344B. The second protruding portions P2A and P2B may protrude in the third direction, may have a planar shape, and may be disposed closer to the separators 600 than the first protruding portions PIA and P1B. The second coupling portions 344A and 344B may be formed in the shape of tongs so as to be engaged with the second protruding portions P2A and P2B. When the second coupling portions 344A and 344B are pressed in the −y-axis direction, which is the second direction, the second coupling portions 344A and 344B may move over the second protruding portions P2A and P2B. To this end, the second coupling portions 344A and 344B may be made of a flexible material, e.g., plastic.

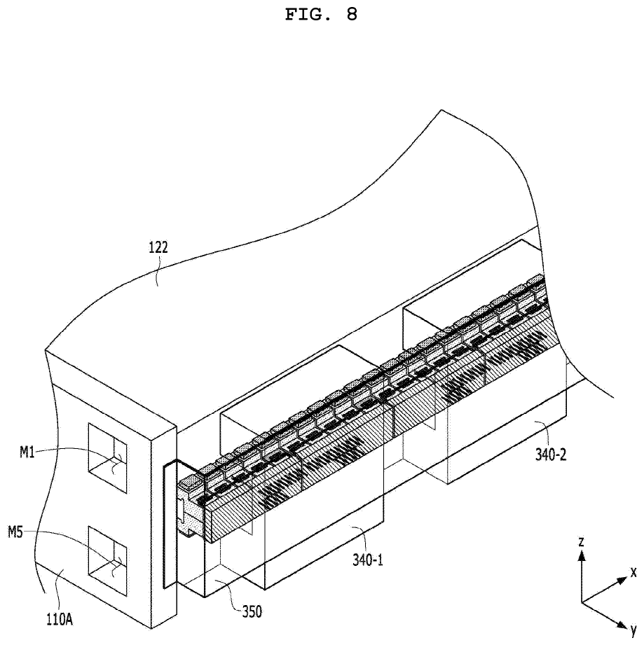

FIG. 8 is a rear perspective view of a cell monitoring device for a fuel cell according to another embodiment. For better understanding, an invisible portion of the cell monitoring device that is hidden by a protective cover 350 is denoted by dotted lines.

The cell monitoring device for a fuel cell according to another embodiment may further include a protective cover 350. The protective cover 350 may be fastened to the fuel cell 200 and may be disposed so as to cover at least a portion of an outermost side of each of the joint connector 330 and the controller 340. For example, the protective cover 350 may be fastened to the first and second end plates 110A and 110B of the fuel cell 200, but the embodiments are not limited thereto.

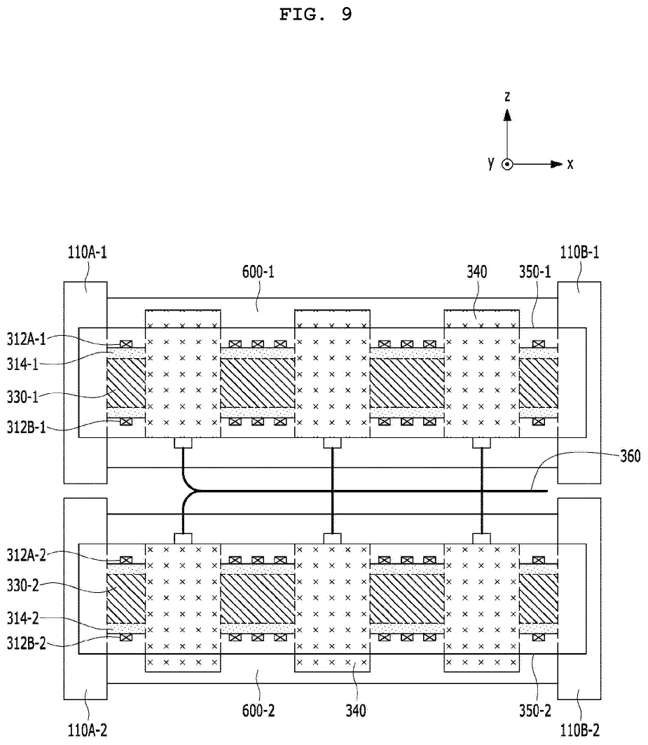

FIG. 9 is a rear view of a cell monitoring device for a fuel cell according to still another embodiment.

The cell monitoring device for a fuel cell shown in FIGS. 1A, 1B, and 5A to 5E may monitor a unit stack module. Here, the unit stack module may correspond to the fuel cell shown in FIG. 2.

According to another embodiment, as shown in FIG. 9, the cell monitoring device for a fuel cell may monitor a plurality of unit stack modules stacked in a vertical direction.

Each of the plurality of unit stack modules shown in FIG. 9 may have the same configuration as the fuel cell 200 shown in FIG. 2. For example, each of the plurality of unit stack modules may include a first end plate 110A-1 (110A-2), a second end plate 110B-1 (110B-2), and a cell stack. A housing 314-1 (314-2) may be coupled to separators 600-1 (600-2) included in the cell stack, and a joint connector 330-1 (330-2) and a controller 340-1 (340-2) may be coupled to the housing 314-1 (314-2). In addition, as described above, CPAs 312A-1 and 312B-1 (312A-2 and 312B-2) are fastened to the housing 314-1 (314-2) in order to prevent the housing 314-1 (314-2) from being separated from the separators 600-1 (600-2), and a protective cover 350-1 (350-2) is fastened to the fuel cell 200. That is, the first end plate 110A-1 (110A-2), the second end plate 110B-1 (110B-2), the separators 600-1 (600-2), the housing 314-1 (314-2), the joint connector 330-1 (330-2), the controller 340-1 (340-2), the CPAS 312A-1 and 312B-1 (312A-2 and 312B-2), and the protective cover 350-1 (350-2) correspond to the first end plate 110A, the second end plate 110B, the separators 600, the housing 314, the joint connector 330, the controller 340, the CPAs 312A and 312B, and the protective cover 350 included in the above-described embodiment, respectively, and thus duplicate description thereof will be omitted.

In general, a fuel cell stack voltage monitor (FSVM) controller may include a cell monitor unit (CMU) and a stack monitor unit (SMU). Here, the CMU may include an integrated circuit (IC) that senses a cell voltage, and the SMU may include a calculation unit that calculates the cell voltage sensed by the CMU and a verification unit that verifies whether a corresponding unit cell normally generates power based on a result of the calculation, and the SMU may transmit a result of the verification to a fuel cell unit (FCU).

According to an embodiment, the cell monitoring device for a fuel cell may further include a sensing unit 346, a calculation unit, and a verification unit.

The calculation unit calculates the measured voltage of each unit cell sensed by the sensing unit 346 of the controller 340 and outputs a result of the calculation to the verification unit. The verification unit may verify whether a corresponding unit cell normally operates using a result of the calculation by the calculation unit.

In this way, according to the embodiment, in the cell monitoring device, the controller 340 is a CMU that only plays the role of the sensing unit 346. As shown in FIG. 9, the controller 340 may further include wires 360 in order to provide the measured voltage of each unit cell sensed by the sensing unit 346 to the calculation unit of the SMU. That is, the measured voltage of each unit cell sensed by the sensing unit 346 may be provided to the calculation unit through the wires 360. To this end, a lower portion of the protective cover 350 may have a cavity formed therein, and the wires 360 connected to the sensing unit 346 of the controller 340 may be led out through the cavity.

Hereinafter, a process of manufacturing the cell monitoring device for a fuel cell according to an embodiment will be described with reference to the accompanying drawings.

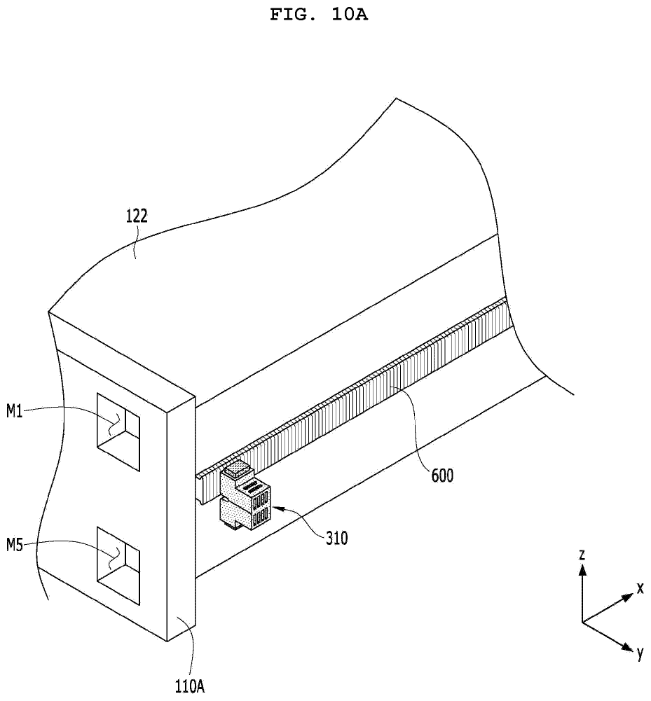

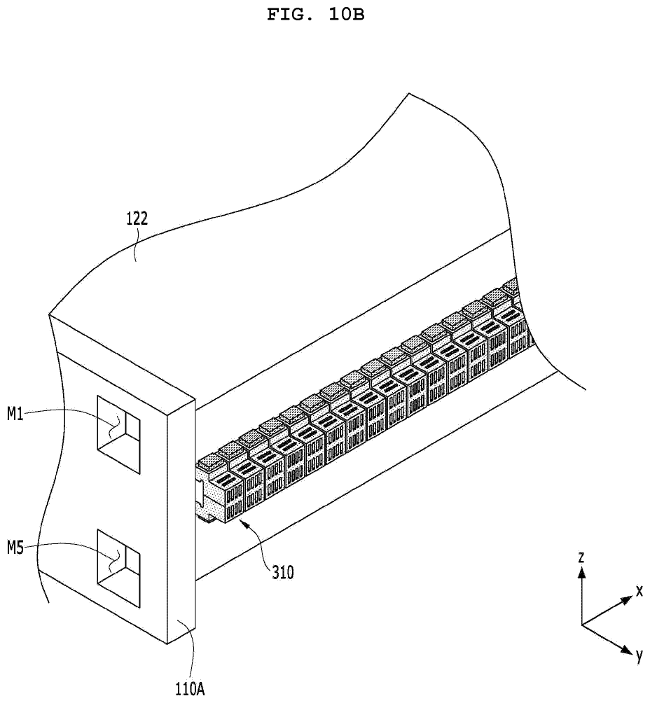

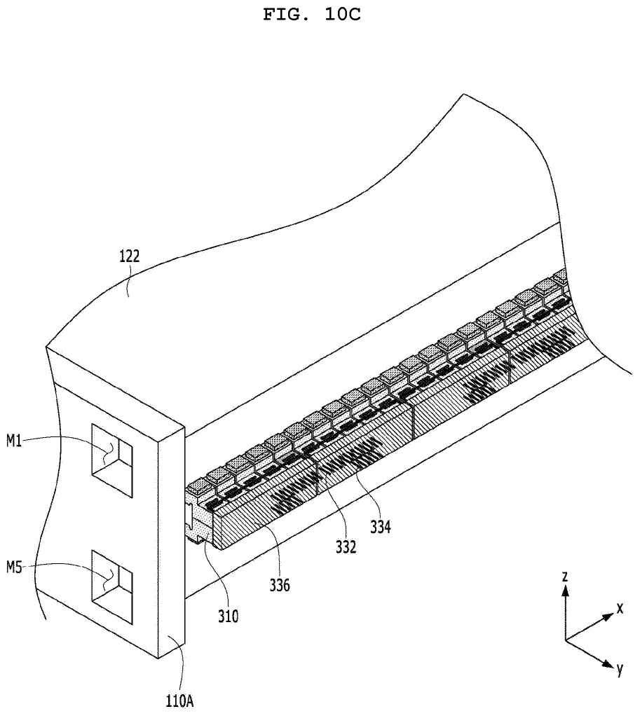

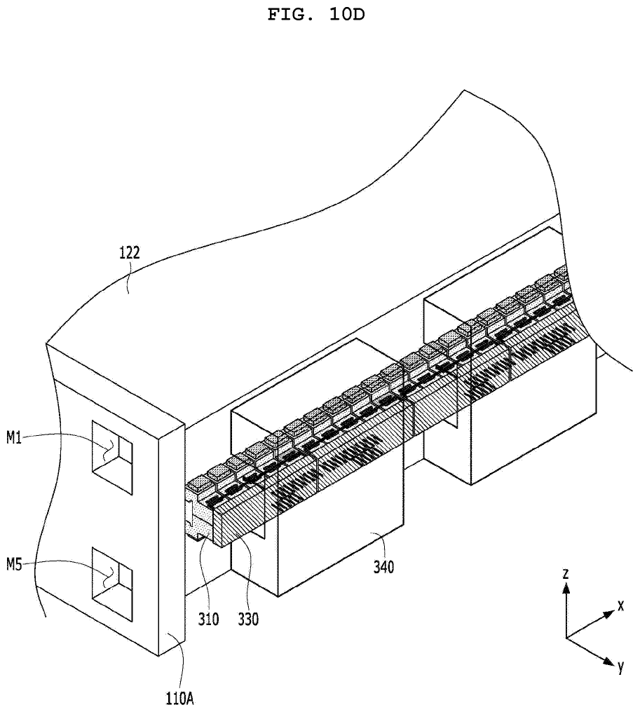

FIGS. 10A to 10D are perspective views showing a process of manufacturing the cell monitoring device according to an embodiment.

Since the components shown in FIGS. 10A to 10D are the same as those described above with reference to FIGS. 1A, 1B, 2, and 5A to 5E, the same components are denoted by the same reference numerals, and duplicate description thereof will be omitted.

First, as shown in FIG. 10A, the cell stack in which the plurality of separators 600 is arranged and the cell monitoring connector 310 are prepared.

Thereafter, as shown in FIG. 10B, the plurality of cell monitoring connectors 310 is coupled to the separators 600, and the CPAS 312A and 312B are fastened to the housing 314 in order to prevent separation of the housing 314 in the second direction.

Thereafter, as shown in FIG. 10C, the joint connector 330 is fastened to the plurality of cell monitoring connectors 310, and the first coupling portions 338A and 338B are engaged with the first protruding portions P1A and P1B so that the joint terminals 332 and 334 are pressed to be inserted into the connection terminals 320.

Thereafter, as shown in FIG. 10D, the controller 340 is placed so as to contact the rear surface of the joint connector 330, and the second coupling portions 344A and 344B are engaged with the second protruding portions P2A and P2B so that the joint terminals 332 and 334 are pressed to be inserted into the connection terminals 320.

Thereafter, as shown in FIG. 8, the protective cover 350 is coupled to the first and second end plates 110A and 110B, thereby completing the manufacture of the cell monitoring device for a fuel cell.

Hereinafter, a cell monitoring device for a fuel cell according to a comparative example and the cell monitoring device for a fuel cell according to the embodiment will be described with reference to the accompanying drawings.

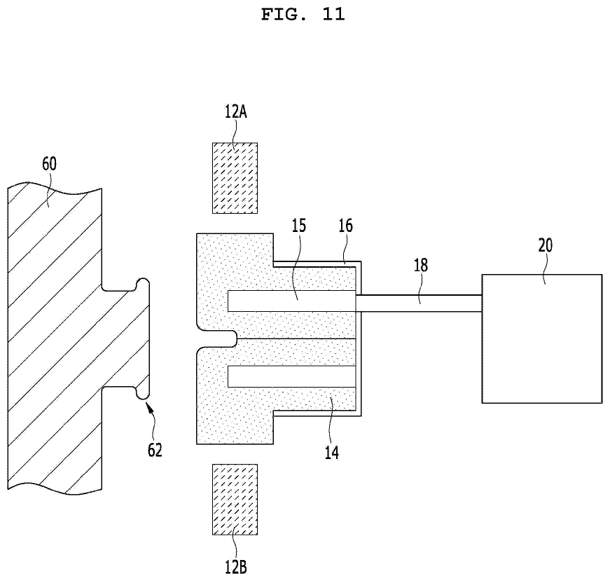

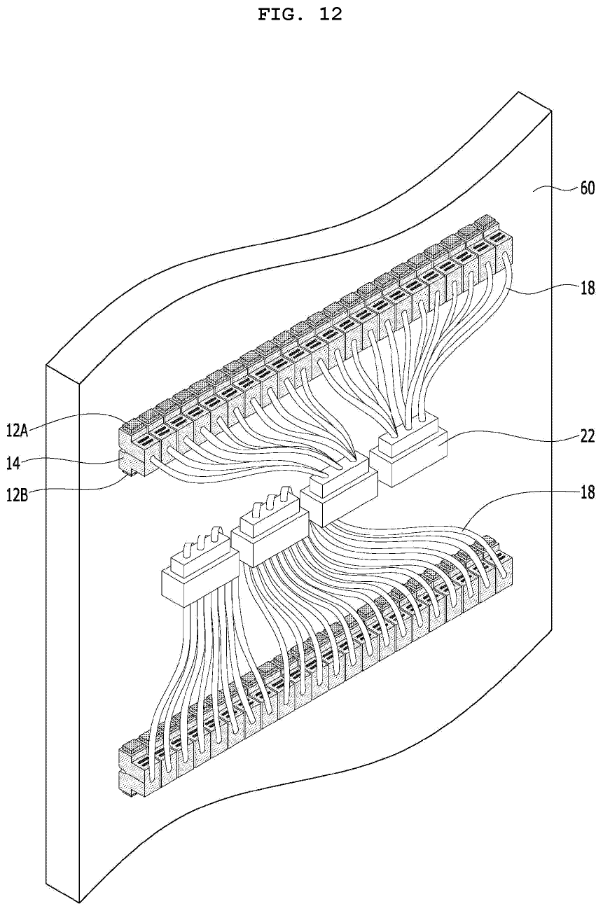

FIG. 11 is a cross-sectional view of a cell monitoring device for a fuel cell according to a comparative example, and FIG. 12 is a partial perspective view of the cell monitoring device according to the comparative example.

The cell monitoring device for a fuel cell according to the comparative example includes a housing 14, CPAs 12A and 12B, a connection terminal 15, a terminal position assurance (TPA) 16, a wire harness 18, a controller 20, and a controller connector 22. The separators 60, the tabs 62, the CPAS 12A and 12B, and the housings 14 of the comparative example perform the same functions as the separators 600, the tabs 610, the CPAs 312A and 312B, and the housings 314 of the above-described embodiment, respectively.

Further, for details of the TPA 16, the connection terminals 15, and the housings 14, reference may be made to, for example, Korean Patent Registration No. 10-1337937.

Unlike the embodiment, according to the comparative example, the connection terminal 15 inserted into the housing 14 connects the wire harness 18 to the tab 62 of the separator 60. The TPA 16 serves to guide the connection terminal 15 to be held in place when the connection terminal 15 is assembled to the housing 14 and to increase the hold of the connection terminal 15.

The controller 20 measures the voltage of the unit cell to which a corresponding separator 60 belongs through the wire harness 18, calculates the measured voltage, and verifies whether the unit cell is defective using a result of the calculation. The controller 20 is fastened to the controller connector 22 shown in FIG. 12.

In the case of the comparative example, the voltage sensed by the connection terminal 15 is transferred to the controller 20 connected to the controller connector 22 through the wire harness 18. The configuration shown in FIG. 12 corresponds to the configuration shown in FIG. 9, in which unit cell stack modules are stacked in the vertical direction. Therefore, a plurality of wire harnesses 18 is located above and below the controller connector 22.

In the comparative example, because bundles of wire harnesses 18 are connected to the connection terminals 15, automated assembly is impossible, and there are many limitations on a package configuration. As the number of bundles of wire harnesses 18 increases in proportion to the number of cells to be sensed, the inner package of the stack may become very narrow. Further, work of engaging the connection terminals to which the wire harnesses 18 are connected with the tabs 62 of the separators 60 is completely manually performed, which leads to increase in labor cost. Even when a cell stack harness is produced as one piece, labor cost accounts for the majority of the production cost because the wire harnesses 18 are almost completely manually manufactured.

In contrast, the embodiment employs the joint connector 330 instead of the wire harnesses 18 without requiring the TPA 16, unlike the comparative example. That is, in the embodiment, the joint terminals 332 and 334 serve as the wire harnesses 18. Therefore, unlike the comparative example using the wire harnesses 18 that should be manually manufactured, according to the embodiment using the joint connector 330, automated assembly may be possible, limitations on a package configuration may be reduced, the size of the inner package of the stack may be secured, and the proportion of labor cost in the production cost may be reduced.

Further, the controller 20 of the comparative example is an FSVM controller that includes both a CMU and an SMU. In contrast, the controller 340 of the embodiment includes only a CMU, and thus the planar area thereof formed by the x-axis and the y-axis may be reduced compared to the comparative example. Accordingly, according to the embodiment, since the area of the controller is smaller than in the comparative example, the overall size of the unit stack module may be reduced. Therefore, when the unit stack module is applied to a vehicle, the volume occupied by the unit stack module in an engine compartment of the vehicle may be reduced. As a result, design of the engine compartment may be facilitated, and the overall volume thereof may be reduced.

When it is intended to enclose the cell monitoring device using the enclosure together with the fuel cell to constitute a unit stack module, the comparative example has a problem in that it is difficult to enclose the wire harnesses 18 using the enclosure. Therefore, after the enclosure is placed so as to enclose the fuel cell, the cell monitoring connector is mounted to the fuel cell. Accordingly, it is difficult for the cell monitoring device to be disposed inside the enclosure together with the fuel cell, and thus there are limitations on a package configuration.

In contrast, according to the embodiment, since the joint connector 330 is used instead of the wire harnesses 18, the joint connector 330 may be enclosed by the enclosure, and thus limitations on a package configuration may be eliminated.

As is apparent from the above description, according to the cell monitoring device for a fuel cell according to the embodiment, automated assembly may be possible, limitations on a package configuration may be reduced, the size of the inner package of the stack may be secured, the proportion of labor cost in production cost may be reduced, design of an engine compartment may be facilitated, and the overall volume of the engine compartment may be reduced.

However, the effects achievable through the embodiments are not limited to the above-mentioned effects, and other effects not mentioned herein will be clearly understood by those skilled in the art from the above description.

The above-described various embodiments may be combined with each other without departing from the scope of the embodiments of the present disclosure unless they are incompatible with each other.

In addition, for any element or process that is not described in detail in any of the various embodiments, reference may be made to the description of an element or a process having the same reference numeral in another embodiment, unless otherwise specified.

While embodiments of the present disclosure have been particularly shown and described with reference to exemplary embodiments thereof, these embodiments are only proposed for illustrative purposes, and do not restrict the embodiments of the present disclosure, and it will be apparent to those skilled in the art that various changes in form and detail may be made without departing from the essential characteristics of the embodiments set forth herein. For example, respective configurations set forth in the embodiments may be modified and applied. Further, differences in such modifications and applications should be construed as falling within the scope of the embodiments of the present disclosure as defined by the appended claims.

What is claimed is:

1. A cell monitoring device for a fuel cell, the cell monitoring device being configured to be mounted to a plurality of unit cells stacked in a first direction, the cell monitoring device comprising:
a cell monitoring connector configured to be detachably coupled to a separator included in the plurality of unit cells to be connected to a tab protruding from a side portion of the separator in a second direction intersecting the first direction;
a joint connector including a joint terminal configured to be guided by a connection terminal to be inserted into the cell monitoring connector, the joint connector being shaped so as to press a first end portion of the joint terminal toward the tab; and
a controller disposed on a rear surface of the joint connector and configured to be directly connected to a second end portion of the joint terminal opposite the first end portion to sense a voltage of each of the plurality of unit cells, the controller being shaped so as to press the first end portion of the joint terminal toward the tab.

2. The cell monitoring device according to claim 1, wherein the cell monitoring connector comprises a housing including a first side coupled to the tab and a second side formed opposite the first side, wherein the connection terminal is configured to be inserted into the second side of the housing to be connected to the tab.

3. The cell monitoring device according to claim 2, wherein the cell monitoring connector comprises a connector position assurance (CPA) configured to be coupled to the housing to prevent the housing from being separated from the separator in the second direction.

4. The cell monitoring device according to claim 2, wherein the connection terminal comprises:
a connection portion configured to be inserted into a connection terminal insertion hole disposed in the second side of the housing to be connected to the tab;
a joint guide portion configured to guide the joint terminal;
a stabilizer protruding in a third direction intersecting each of the first and second directions to prevent the connection terminal from being inserted inversely into the housing; and
a locking protrusion that is bent and extends downward from the connection portion.

5. The cell monitoring device according to claim 4, wherein:
the joint connector further comprises a joint body configured to allow the joint terminal to pass therethrough and disposed between the cell monitoring connector and the controller; and
the first end portion of the joint terminal is configured to be inserted into the joint guide portion to be disposed in the connection terminal.

6. The cell monitoring device according to claim 5, wherein the controller comprises:
a control body configured to be directly connected to the second end portion of the joint terminal and to contact the rear surface of the joint connector; and
a sensing device configured to be directly connected to the second end portion of the joint terminal to sense the voltage.

7. The cell monitoring device according to claim 6, wherein the joint body comprises first coupling portions configured to be coupled to the housing while pressing the joint terminal in a direction in which the first end portion of the joint terminal is inserted into the joint guide portion.

8. The cell monitoring device according to claim 7, wherein:
the housing comprises first protruding portions protruding in the third direction; and
the first coupling portions have a shape of tongs so as to be engaged with the first protruding portions.

9. The cell monitoring device according to claim 7, wherein the control body comprises second coupling portions configured to be coupled to the housing while pressing the joint terminal in a direction in which the first end portion of the joint terminal is inserted into the joint guide portion.

10. The cell monitoring device according to claim 9, wherein:
the housing comprises second protruding portions protruding in the third direction and disposed closer to the separator than the first protruding portions; and
the second coupling portions have a shape of tongs so as to be engaged with the second protruding portions.

11. The cell monitoring device according to claim 1, further comprising a protective cover configured to be fastened to the fuel cell to cover a portion of an outermost side of each of the joint connector and the controller.

12. A system for monitoring a fuel cell, the system comprising:
the fuel cell comprising a plurality of unit cells stacked in a first direction and a separator is included in the plurality of unit cells, wherein a tab protrudes from a side portion of the separator in a second direction intersecting the first direction; and
a cell monitoring device being configured to be mounted to the plurality of unit cells, the cell monitoring device comprising:
a cell monitoring connector configured to be detachably coupled to the separator to be connected to the tab, the cell monitoring connector comprising a housing including a first side coupled to the tab and a second side formed opposite the first side;
a joint connector including a joint terminal configured to be guided by a connection terminal to be inserted into the cell monitoring connector, wherein the joint connector is shaped so as to press a first end portion of the joint terminal toward the tab, and wherein the connection terminal is configured to be inserted into the second side of the housing to be connected to the tab;
a controller disposed on a rear surface of the joint connector and configured to be directly connected to a second end portion of the joint terminal opposite the first end portion to sense a voltage of each of the plurality of unit cells, the controller being shaped so as to press the first end portion of the joint terminal toward the tab; and
a protective cover configured to be fastened to the fuel cell to cover a portion of an outermost side of each of the joint connector and the controller.

13. The system according to claim 12, wherein the cell monitoring connector comprises a connector position assurance (CPA) configured to be coupled to the housing to prevent the housing from being separated from the separator in the second direction.

14. The system according to claim 12, wherein the connection terminal comprises:
a connection portion configured to be inserted into a connection terminal insertion hole disposed in the second side of the housing to be connected to the tab;
a joint guide portion configured to guide the joint terminal;
a stabilizer protruding in a third direction intersecting each of the first and second directions to prevent the connection terminal from being inserted inversely into the housing; and
a locking protrusion that is bent and extends downward from the connection portion.

15. The system according to claim 14, wherein:
the joint connector further comprises a joint body disposed between the cell monitoring connector and the controller and configured to allow the joint terminal to pass therethrough; and
the first end portion of the joint terminal is configured to be inserted into the joint guide portion to be disposed in the connection terminal.

16. The system according to claim 15, wherein the controller comprises:
a control body configured to be directly connected to the second end portion of the joint terminal and to contact the rear surface of the joint connector; and
a sensing device configured to be directly connected to the second end portion of the joint terminal to sense the voltage.

17. The system according to claim 16, wherein the joint body comprises first coupling portions configured to be coupled to the housing while pressing the joint terminal so that the first end portion of the joint terminal is inserted into the joint guide portion.

18. The system according to claim 17, wherein:
the housing comprises first protruding portions protruding in the third direction; and
the first coupling portions have a shape of tongs so as to be engaged with the first protruding portions.

19. The system according to claim 17, wherein the control body comprises second coupling portions configured to be coupled to the housing while pressing the joint terminal so that the first end portion of the joint terminal is inserted into the joint guide portion.

20. The system according to claim 19, wherein:
the housing comprises second protruding portions protruding in the third direction and disposed closer to the separator than the first protruding portions; and
the second coupling portions have a shape of tongs so as to be engaged with the second protruding portions.
